(19) United States
(12) Patent Application Publication
(10) Pub. No.: US 2020/0032703 A1
(43) Pub. Date: Jan. 30, 2020

(54) SUPERCRITICAL WATER GENERATOR AND REACTOR

(71) Applicant: Federico Marquez Lopez, Chihuahua (MX)

(72) Inventor: Federico Marquez Lopez, Chihuahua (MX)

(21) Appl. No.: 16/477,271

(22) PCT Filed: Jan. 15, 2018
(86) PCT No.: PCT/IB18/50235

§ 371 Date: Jul. 11, 2019

Related U.S. Application Data
(60) Provisional application No. 62/447,075, filed on Jan. 17, 2017.
(60) Provisional application No. 62/488,748, filed on Apr. 22, 2017.
(60) Provisional application No. 62/571,229, filed on Oct. 11, 2017.

(51) Int. Cl. F02C 3/30; F01K 25/06; F02M 25/025; F02M 25/032; F22B 3/08; F22B 35/08; F22B 35/12

(52) U.S. Cl. CPC F02C 3/30; F01K 25/06; F02M 25/025; F22B 35/12; F22B 3/08; F22B 35/086; F02M 25/032

(57) ABSTRACT

Here is described a process to transform energy in chemical form in fuels into electric power through a thermal process. It combines advantages of the traditional internal combustion engine and the steam engine by producing supercritical combustion to allow direct mixture of combustion gases with additional working fluid to cool the mixture to operational conditions. The process allows the control of the inlet temperature of the turbine or expander and makes direct heat exchange by mixing working fluids. The combustion gases are completely used as working fluid in contrast to steam generator. The process improves the efficiency compared to combined cycle or traditional supercritical plants.

### REFERENCE TO RELATED APPLICATIONS

This application claims the priority and incorporates by reference of U.S. Provisional Patent Applications 62/447,057, filed on Jan. 17; 2017, 62/488,748, filed on Apr. 22, 2017; and 62/571,229 filed on Oct. 11 2017.

### BACKGROUND OF THE INVENTION

The present invention relates to the field of thermoelectric power generation and chemical reactors.

Thermoelectric power conversions are usually conducted by reacting fuels with an oxidizer that changes the density of matter producing expansion as a working fluid either by internal combustion or by indirect heat exchange to a fluid with the principle of the steam engine.

Supercritical water generator is now routinely used for production of electric power. In a typical supercritical water generator, water enters the boiler at a pressure above the critical pressure (221 Bar) and is heated to a temperature above the critical temperature (706° F. or 374° C.). Due to the supercritical state of water, supercritical generators eliminate the need for separating water from steam. They also provide a somewhat better fuel efficiency compared to sub-critical steam generators. However, currently available supercritical generators use indirect heating of the boilers, resulting in limited efficiency.

It is desirable to increase the efficiency of thermoelectric power conversion by combining the advantages of internal combustion and supercritical power generation

### SUMMARY OF THE INVENTION

The present invention combines the principles of internal combustion and steam engine. At given conditions, the proposed system makes it possible to conduct direct heat exchange by mixing the combustion products with an additional fluid and use the mixture as a working fluid. The advantages of the proposed system include the following: 1. Direct heat exchange is much more efficient than the indirect heat change; 2. The working fluid temperature can be adjusted by the amount of additional working fluid; 3. The operational temperature can be controlled without using excess air to cool down the system like gas turbine does; 4. The operation is performed with optimized expansion rate of the fluid; 5. The cooling of the machine is achieved with the same working fluid to be added, not wasting heat, 6 Traditional boilers loose the fluids of combustion through the chimney, this method uses the combustion products as working fluid and being pressurized power is obtained from them, and 7. Fuel Turbines need to use excess air to cool the working fluids of combustion to operational conditions that the turbine material is capable to handle. Here the cooling is achieved by water or other working fluid that has better expansion rate with heating than air, improving the efficiency.

To make it possible to conduct direct heat exchange between the combustion fluids and the additional working fluid, it requires that the combustion happens at a pressure equal or above the fluid's critical point to obtain a supercritical fluid from the combustion. This combustion fluid gases at the supercritical state, and water can be added as additional working fluid to cool the mixture into an operating temperature. Water at supercritical state does not boil or separate in condensed and steam states, so the right amount of water added makes a supercritical working fluid mixture.

A proper design for the supercritical working fluid mixture given by the fuel and added working fluid will produce an efficient power generation. Turbine is adequate and other mechanism such as reciprocating can be used also to produce power.

A variety of fuels can be used, such as water-coal slurry, natural gas, hydrogen, petroleum and others. The main products of supercritical combustion using hydrocarbons, coal or hydrogen are carbon dioxide and/or water in the supercritical phase. Therefore, by adding the proper amount of water, the fluids will still be supercritical and most of it is supercritical water and carbon dioxide, or just water in the case of hydrogen as fuel.

Pressure in combustion has an effect on adiabatic flame. Therefore, the high pressure combustion in oxy fuel generates very high temperature. This does not necessarily require the materials making the combustion chambers to tolerate high temperature, because the temperature of the chamber can be controlled by cooling it with the working fluid to be added, such as water, keeping the combustion chamber cool while pre-heating the working fluid which will be injected to the working fluid chamber, without loosing heat.

The ideal combustion for this process is using oxy fuel. Pure oxygen combustion is ideal because the heat is not spent heating the nitrogen in air. Other fluids such as water have better expansion ratio, so it is better to use that heat in injecting a working fluid than nitrogen being heated in the combustion. Although nitrogen at that pressure and with the heat of combustion is also supercritical, other fluids may recover more mechanical power from that heat.

In the present invention, the working pressure is set to be at or above the critical point of the working fluids. For example, if water is used as the additional working fluid, the combustion has to be made at or above 221 Bar, which is the critical point for water, and the minimum operating temperature is above 374 Celsius. It is possible to operate in other conditions but those other conditions are not ideal. Under the ideal working conditions, the additional injected water becomes supercritical in the heat exchange. If the conditions are below that the state, water will become liquid, vapor, superheated steam or superheated water, which is not adequate for operation. Other systems using direct heat exchange without reaching supercritical combustion requires an additional step to separate the liquid water from steam.

The supercritical state of fluids brings other characteristics. For example, many materials containing carbon react with supercritical water, for example, methane contained in natural gas hydrolyzes into hydrogen and carbon dioxide, or cellulose also hydrolyses into hydrogen or methane and carbon dioxide or carbon monoxide. If the additional working fluid used to cool the combustion supercritical gases contains one of the materials reactive with supercritical water, the material will transform into value chemicals such as hydrogen which is used in fertilizers production process. This process can be made by making a slurry that contains the reacting material or adding a working fluid that reacts, so the present invention performs power conversion and valuable chemical production in the same vessel or chamber.

The reaction can also be conducted in traditional boilers for supercritical water, by adding a slurry or material that reacts. The advantage of this approach is that most of the reactions will produce a density change that helps the volume of the working fluid expanding more and thus increasing available work. Injecting the reacting material in the additional working fluid produces the two advantages in the same process. It can be made by high pressure combustion with additional working fluid, or by a boiler and additional working fluid.

Direct heat exchange is the mixture of materials of different temperature. The heat exchange will go from the hotter fluid into the colder one, the efficiency is very close to 100, indirect heat exchange raises the temperature of the fluid by heating its container. Some of the heat escapes making it at an efficiency of 81% at the most. This difference is the main reason that the present invention improves efficiency. Here, a combination of the internal combustion engine and the steam engine principles are used together by changing the conditions of combustion to produce supercritical combustion gases capable of direct heat exchange to other fluids changing their state into supercritical without boiling or indirect heat exchange. The conditions of supercritical fluids used for power generation can also be used for secondary reactions, being the excess fluid used as working fluid for power generation and the chemicals of the secondary reaction obtained at a lower cost of energy.

### BRIEF DESCRIPTION OF THE DRAWINGS

FIG. 1 is a block diagram showing the power generation process.

FIG. 2 is an embodiment of the combustion chamber.

FIG. 3 is an embodiment of operation of the combined production of power and chemical products by supercritical fluid in a boiler or a conventional supercritical heater.

### REFERENCE NUMERALS IN THE DRAWINGS

Reference is now made to the following components of embodiments and steps of operation of the present invention:
101 Fuel compressor
102 Oxidant compressor
103 Fuel mixer
104 Combustion chamber
105 Mixing chamber
106 Turbine
107 Power
108 Water pump
109 Water
110 Turbine outlet
111 Fuel
112 Oxidant
113 Reacting material
201 Chamber
202 Chamber wall
203 Injection aperture
204 Combustion chamber
205 Cavity
301 Heater
302 Water
303 Methane/natural gas
304 Carbon/Carbon rich material
305 Fire tube structure
306 Valve
307 Chimney
309 Outlet
310 Outlet

### DETAILED DESCRIPTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described herein. Additionally, some well-known structures or functions may not be shown or described in detail, so as to avoid unnecessarily obscuring the relevant description of the various embodiments.

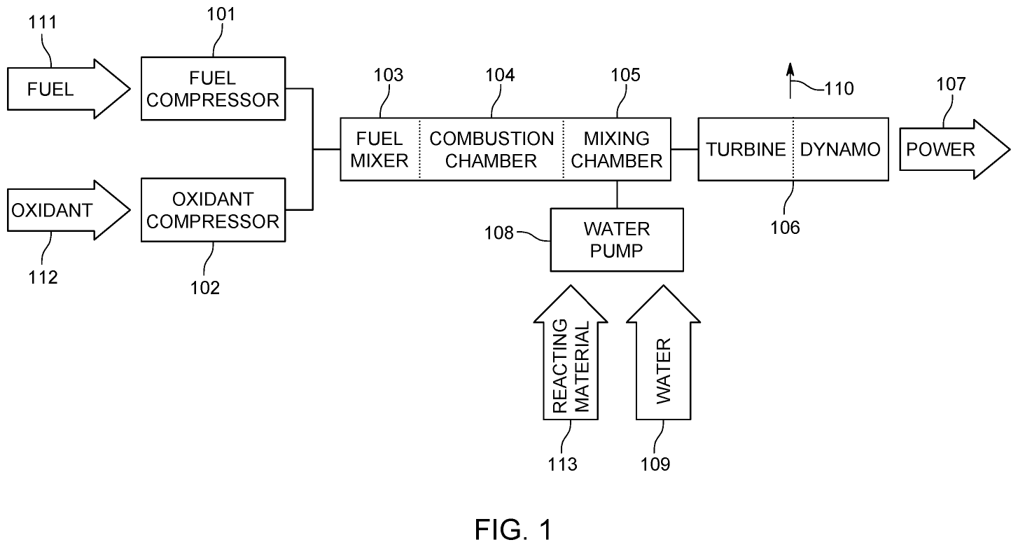

FIG. 1 shows the overall process of an embodiment of the present invention. The process shown in FIG. 1 has similarity to a gas turbine with the difference that the operating pressure is above water critical point, and that after burning the fuel and the combustion is over, water or a slurry is added to cool down the mixture to the operating temperature. This way the machine materials can handle the high temperature. And the additional water is useful as working fluid for turbine or expander.

In one embodiment, methane is used as the fuel 111, pure oxygen as the oxidant 112, and water as the cooling working fluid 109. The process initializes with providing the fuel 111 to the fuel compressor 101 and oxidant 112 to the oxidant compressor 102. This is needed to produce the conditions for pressured combustion. In some cases such as when using combustion of hydrogen with oxygen, other methods of compression might be possible, such as high pressure electrolysis. Fuel 111 and oxidant 112 are mixed in the fuel mixer 103, which is connected to the combustion chamber 104 and maintains isobaric conditions with it. In this case as water is used as the cooling working fluid 109, it requires the pressure to be at or above 221 Bar which is the critical pressure for water. When the fuel 111 and oxidant 112 are mixed at this pressure they will auto ignite. In general, depending on the fuel, a glow bulb or spark plug may be needed to initialize the combustion in the combustion chamber 104. Since the combustion temperature (3549 Celsius at 280 Bar) is above the cooling working fluid critical temperature (374 Celsius for water 109), it is possible to add water 109 at the supercritical pressure without losing the overall working fluid condition of supercritical. The reaction product of fuel 111 and oxidant 112 combustion at this conditions are supercritical carbon dioxide and water. Even after adding the appropriate amount of water 109, the working fluid mixture in the mixing chamber 105 will keep supercritical. The working fluid mixture result at the end of the mixing chamber 105 will have the ideal conditions to operate in the turbine 106, or an expander. The result will be power generation, in this case electric power 107 and the working fluid vapors as turbine outlet 110. The vapors will be carbon dioxide (gas) and water (steam). As a result, the operating conditions can be made ideal, without indirect heat exchangers losing heat into atmosphere. In addition, in the system of the present invention uses complete heat of the fuel in one simple cycle instead of two combined cycles, and uses a single turbine 106 or expander instead of two used in combined cycle—one for gas turbine and the other for steam turbine.

Additional benefits can be obtained as advantage of secondary reactions. Supercritical fluids allow different reactions. For example, carbon or materials containing carbon react with supercritical water. The process is called hydrolysis and it converts different material into valuable products, such as convert methane into carbon dioxide and hydrogen, or cellulose into hydrogen and carbon dioxide or some carbon monoxide and methane. When combining the two reactions in a simple process, it produces power and chemicals. When excess methane is provided as fuel 111 with the oxidant 112 for combustion, unburned methane will be available to react with the supercritical water from the combustion or the cooling water 109, causing hydrolysis to occur in the combustion chamber 104 or in the mixing chamber 105, producing valuable chemicals by the outlet 110 of the turbine 106 or expander. This makes it possible for the co-production of chemicals such as hydrogen for fertilizer industry with the power generation 107.

This additional reaction can also be produced by adding the reacting material 113 into the mixing chamber in a form of slurry, liquid or a gas, such as cellulose slurry, biomass, hydrocarbon or methane to react and hydrolyze in the mixing chamber 105 and be recovered as valuable chemicals in the outlet 110 of the turbine 106 or expander.

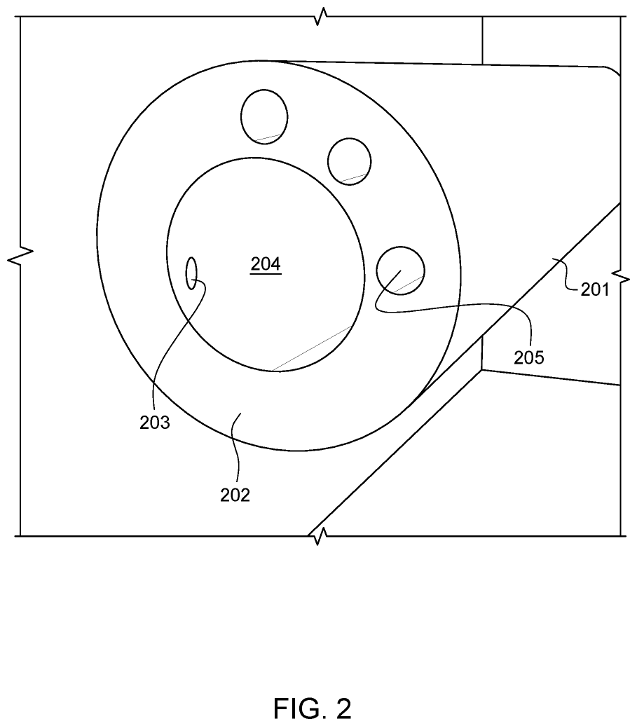

FIG. 2 shows the process to make it possible for the operation of a chamber 201 under the conditions of high temperature and high pressure without losing heat. Inside of the combustion chamber 204 high temperature and pressures are needed. Combustion as high as 3500 Celsius can be reached with methane. This temperature is above the melting points of many alloys and much higher than the temperature with which many materials lose the strength to withstand the high pressure combustion. It is needed that the chamber wall 202 is in optimal conditions so it can handle the operation. In this embodiment, the chamber wall 202 is cooled by a fluid in its cavities 205. The fluid in this case is cooling water that is preheated by the chamber 201 while cooling it, and then is introduced by cavities 205. It is sprayed or injected through an injection aperture 203 into the interior of the chamber 204. The fluid works as cooling fluid, working fluid and possibly as a reacting material.

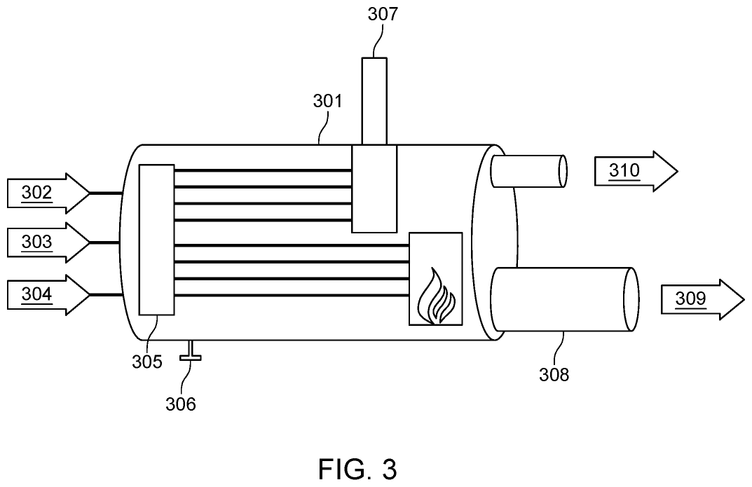

FIG. 3 demonstrates the operation of the combined production of power and chemical products by supercritical fluid in a boiler or a conventional supercritical heater. For example, supercritical water has pressure and temperature ideal to produce power, and at the same time a hydrolysis chemical reaction is generated in the supercritical water, yielding chemical production and power generation in the same process.

FIG. 3 shows a traditional heater 301 heated by indirect heat transfer. The heater 301 comprises a fire tube structure 305 that contains the combustion gases heating the supercritical fluid. The heater 301 can also take advantage of the process of power generation to make chemical production in the same supercritical process, with some heat loss by the chimney 307 but still offering many of the advantages. Here the traditional supercritical water heater 301 is fed with water 302 as it is commonly done. In order to also produce chemical products in addition to working fluid, methane or natural gas 303 is also fed to the heater. The mixture of methane and water at supercritical conditions generates hydrolysis, which produces hydrogen and carbon monoxide. The production of hydrogen is valuable as a chemical, and the carbon monoxide can be used as a fuel. Since the reaction is conducted under pressure, the fluids can be used as working fluid producing power. It is advantageous that the lower density of the hydrogen and carbon monoxide produced compared to the reacting methane and supercritical water since an additional volume is obtained generating more power. The working fluid and chemicals will exit the supercritical heater by the outlet 309. This working fluid is ready for a turbine or an expander. After producing work, the chemicals can be recovered from the working fluid.

Different mixtures of reacting materials can be used. For example a slurry of water with carbon or carbon rich material 304 can be fed into the supercritical heater 301, making hydrolysis reactions and producing power and chemicals. If the slurry produces not only fluid but also solids, the solids can be drained by a valve 306 to prevent the turbine or expander damage.

The outputs 309 and 310 of the fluids contained in the vessel can be located at different altitudes of the vessel contributing to separating the fluids of different densities. For example, hydrogen at 300 Bar and 600° C. has a density that is more than 10 times lower than the water density at the same conditions. This can help to recover the fluids separately. Power can still be obtained from the fluids as they can produce work either by the same turbine or expander or separated ones.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. A process for electric power generation, comprising
injecting a fluid to supercritical gasses resulted from pressurized combustion at a pressure equal or above of the critical pressure of the fluid to produce a supercritical fluid.

2. The process in claim 1, wherein the fluid being injected is water.

3. The process in claim 2, further comprising
making a direct heat exchange of pressurized combustion gases at water supercritical pressure or above with the injected water to produce supercritical water, either pure or mixed with supercritical carbon dioxide,
producing power from the direct mixture supercritical fluid generator, and
producing chemical reactions in the in of the machine to produce power and chemicals.

4. The process in claim 3, further comprising cooling the machine body with the fluid being injected and used as working fluid.

5. The process in claim 4, further comprising injecting carbon or material rich in carbon to the interior of a supercritical water vessel to produce hydrolysis reaction and obtain chemicals and power in the same process.

6. The process in claim 5, further comprising injecting water to a pressurized combustion vessel at water supercritical pressure to cool the working fluid mixture.

7. The process in claim 6, further comprising providing excess fuel to the supercritical combustion vessel to react it with supercritical fluids from the combustion or working fluid and produce hydrolysis reaction.

8. The process in claim 7, wherein the same vessel or pipeline is used to heat fluid to critical point or above for power generation and hydrolysis reaction at the same process.

9. The process in claim 8, wherein the fluid is a slurry of carbon or carbon rich material.

10. The process in claim 8, wherein the fluid is water and a gas is also injected to produce the hydrolysis reaction.

11. The process in claim 8, wherein the vessel containing supercritical mixture of fluids to produce power, chemicals or both has more than one outlet at different heights to separate the fluids by the density difference.
